(19) United States
(12) Patent Application Publication
(10) Pub. No.: US 2014/0152578 A1
(43) Pub. Date: Jun. 5, 2014

(54) Electronic Device, Keyboard Control System, Display Control Method, and Computer Program Product

(71) Applicant: Kabushiki Kaisha Toshiba, Tokyo (JP)

(72) Inventor: Kazuyo Kuroda, Suginami-ku (JP)

(21) Appl. No.: 13/935,922

(22) Filed: Jul. 5, 2013

(30) Foreign Application Priority Data
Nov. 30, 2012 (JP) 2012-263733

(51) Int. Cl. G06F 3/02

(52) U.S. Cl. CPC G06F 3/0227
USPC 345/172

(57) ABSTRACT

According to one embodiment, an electronic device includes a connector, a display module, and a receiver. The connector is configured to be connectable to a device comprising a keyboard. The display module is configured to display a software keyboard on which a key not comprised in the keyboard of the device is arranged when the device is connected to the connector. The receiver is configured to receive input from the key displayed as the software keyboard on the display module.

### CROSS-REFERENCE TO RELATED APPLICATIONS

This application is based upon and claims the benefit of priority from Japanese Patent Application No. 2012-263733, filed Nov. 30, 2012, the entire contents of which are incorporated herein by reference.

### FIELD

Embodiments described herein relate generally to an electronic device, a keyboard control system, a display control method, and a computer program product.

### BACKGROUND

Conventionally, there has been developed a technology for displaying a software keyboard to input a character string and the like in a tablet terminal. In recent years, there has also been developed a technology for changing a display format of a software keyboard depending on usage of a user even in a device comprising an actual hardware keyboard.

The conventional technology does not consider a model of a connected hardware keyboard and a physical change, such as a change in the number of physical keys, when displaying a software keyboard.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration of an electronic device and a keyboard device serving as a keyboard control system according to a first embodiment;

FIG. 2 is an exemplary block diagram of a hardware configuration of the electronic device in the first embodiment;

FIG. 3 is an exemplary schematic diagram of the keyboard device in the first embodiment;

FIG. 4 is an exemplary schematic diagram illustrating a state in which a row of function keys is removed from the keyboard device in the first embodiment;

FIG. 5 is an exemplary schematic diagram of wirings of keys on a keyboard device 150 in the first embodiment;

FIG. 6 is an exemplary schematic diagram of the keyboard device from which the row of function keys is removed in the first embodiment;

FIG. 7 is an exemplary schematic diagram of a software keyboard displayed by a display module when the keyboard device from which the row of function keys is removed is connected to the electronic device in the first embodiment;

FIG. 8 is an exemplary schematic diagram of the keyboard device from which a row of numeric keys is removed in the first embodiment;

FIG. 9 is an exemplary schematic diagram of a software keyboard displayed by the display module when the keyboard device from which the row of numeric keys is removed is connected to the electronic device in the first embodiment;

FIG. 10 is an exemplary flowchart of a display process of the software keyboard in the electronic device and the keyboard device in the first embodiment;

FIG. 11 is an exemplary schematic diagram of a configuration of an electronic device and a keyboard device serving as a keyboard control system according to a second embodiment;

FIG. 12 is an exemplary schematic diagram illustrating a state in which the electronic device is connected to a plurality of input devices in the second embodiment;

FIG. 13 is an exemplary schematic diagram of a setting screen displayed by a display module according to a third embodiment; and

FIG. 14 is an exemplary schematic diagram of a list screen of displayable keys displayed by the display module in the embodiment.

### DETAILED DESCRIPTION

In general, according to one embodiment, an electronic device comprises a connector, a display module, and a receiver. The connector is configured to be connectable to a device comprising a keyboard. The display module is configured to display a software keyboard on which a key not comprised in the keyboard of the device is arranged when the device is connected to the connector. The receiver is configured to receive input from the key displayed as the software keyboard on the display module.

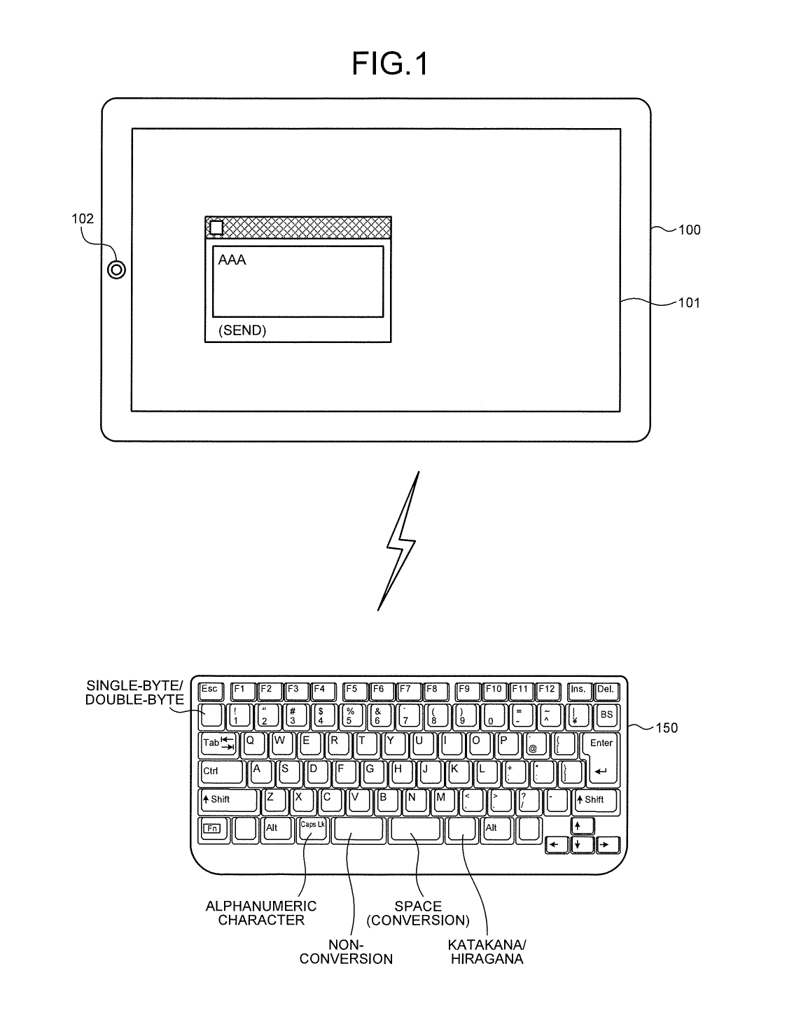

FIG. 1 is a schematic diagram of a configuration of an electronic device 100 and a keyboard device 150 serving as a keyboard control system 1 according to a first embodiment. While an explanation will be made for the case in which the electronic device 100 and the keyboard device 150 are connected via wireless communications in the first embodiment, they are not necessarily connected via wireless communications. The electronic device 100 and the keyboard device 150 may be connected via wired communications of a universal serial bus (USB), for example.

The electronic device 100 illustrated in FIG. 1 is a portable terminal (e.g. a tablet terminal) and comprises a display device 101 and a camera module 102. The display device 101 comprises a touch panel sensor and can receive an input of positional coordinates by contact.

The keyboard device 150 is a hardware keyboard connectable to the electronic device 100 in a wireless or wired manner. The shape of the keyboard device 150 is not particularly limited, and the keyboard device 150 may be provided to a cover of the electronic device 100, for example. If the keyboard device 150 is connected to the electronic device 100, a user can use the keyboard device 150 as an input apparatus (an input device) of the electronic device 100 to operate the electronic device 100 and input a character string, for example.

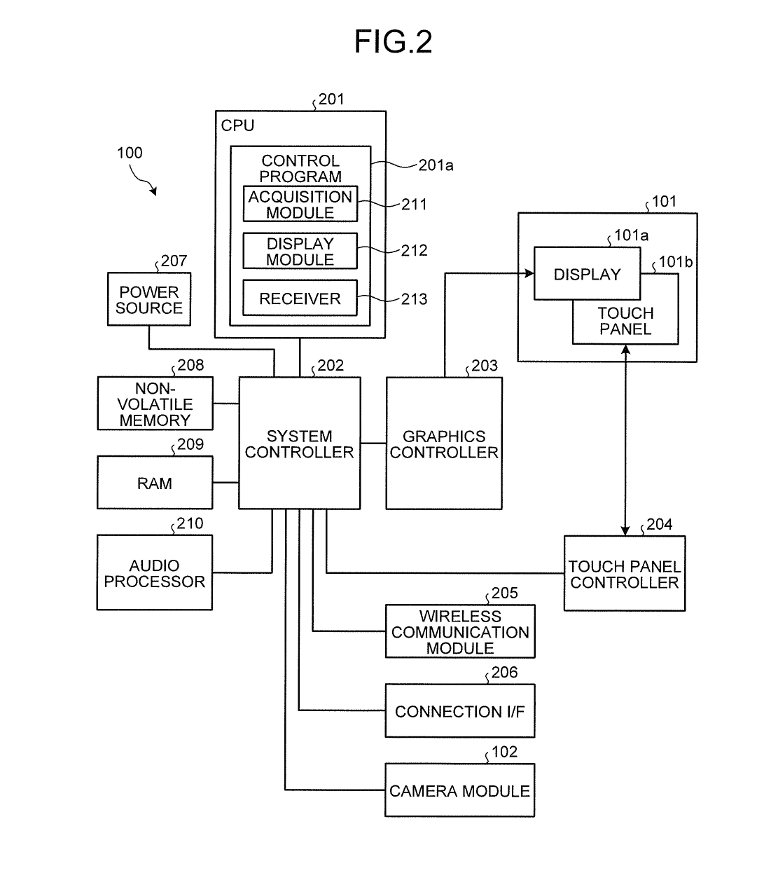

FIG. 2 is a block diagram of an example of a hardware configuration of the electronic device 100 according to the first embodiment. As illustrated in FIG. 2, the electronic device 100 according to the first embodiment comprises the display device 101, a central processing unit (CPU) 201, a system controller 202, a graphics controller 203, a touch panel controller 204, a wireless communication module 205, a connection interface (I/F) 206, the camera module 102, a power source 207, a non-volatile memory 208, a random access memory (RAM) 209, and an audio processor 210.

In the first embodiment, the display device 101 comprises a touch panel 101b and a display screen (a display) 101a, such as a liquid crystal display (LCD) and an organic electro luminescence (EL). The touch panel 101b has a function to detect positional coordinates arranged on the display screen 101a, for example. The touch panel 101b, for example, can detect a position (a touch position) on a display area of the display screen 101a touched by a finger of the user holding the electronic device 100. This operation of the touch panel 101b enables the display screen 101a to function as what is called a touch screen.

The CPU 201 is a processor that collectively controls operations of the electronic device 100 and controls each module of the electronic device 100 via the system controller 202. The CPU 201 executes an operating system (OS) loaded from the non-volatile memory 208 onto the RAM 209. Furthermore, the CPU 201 executes a control program 201a on the OS. The RAM 209 serves as a main memory of the electronic device 100 and provides a work area for the CPU 201 to execute computer programs.

The system controller 202 has a built-in memory controller that accesses to control the non-volatile memory 208 and the RAM 209. The system controller 202 also has a function to perform communications with the graphics controller 203. Furthermore, the system controller 202 has a built-in microcomputer in which an embedded controller is integrated. The embedded controller controls the power source 207 that supplies power stored in a battery (not illustrated) provided to the electronic device 100.

The graphics controller 203 is a display controller that controls display of an image on the display screen 101a used as a display monitor of the electronic device 100. The touch panel controller 204 controls the touch panel 101b and acquires coordinate data indicating a touch position touched by the user on the display screen 101a from the touch panel 101b.

The wireless communication module 205 performs data communications with a device with which wireless communications can be established. In the first embodiment, the wireless communication module 205 performs wireless communications with other devices, such as the keyboard device 150, with Bluetooth (registered trademark), for example. The method of the wireless communications is not limited to Bluetooth (registered trademark), and another communication standard, such as a wireless local area network (LAN) standard Institute of Electrical and Electronic Engineers (IEEE) 802.11n, may be used.

The connection I/F 206 is a wired connection I/F connectable to a device such as the keyboard device 150. The system controller 202 has a function to receive a signal from the device connected via the connection I/F 206. Therefore, if the keyboard device 150 is connected via the connection I/F 206, the user can perform various operations using the keyboard device 150.

The camera module 102 can capture an external environment around the electronic device 100. Image data obtained by capturing of the camera module 102 can be processed by the CPU 201 via the system controller 202.

The audio processor 210 performs audio processing, such as digital conversion, noise reduction, and echo cancellation, on an audio signal received through a microphone (not illustrated) and outputs the audio signal to the CPU 201. Furthermore, the audio processor 210 performs audio processing, such as an audio synthesis, on an audio signal and outputs the audio signal thus generated to a speaker (not illustrated) under the control of the CPU 201, thereby outputting audio from the speaker.

The control program 201a of the CPU 201 is a computer program running on the OS executed by the CPU 201 and comprises an acquisition module 211, a display module 212, and a receiver 213. The control program 201a performs control related to a software keyboard, for example.

The acquisition module 211 acquires the type of the keyboard device 150 connected via the wireless communication module 205 or the connection I/F 206 or acquires key codes arranged on a keyboard unit provided to the keyboard device 150.

The display module 212 performs control for displaying on the display screen 101a of the display device 101. In response to a request from the user, the display module 212 displays a software keyboard on the display screen 101a, for example.

If a keyboard device is connected via the wireless communication module 205 or the connection I/F 206, the display module 212 according to the first embodiment displays a software keyboard on which keys not included in a keyboard unit of the keyboard device are arranged based on the type of the keyboard device or key codes of keys provided to the keyboard device acquired by the acquisition module 211.

Specifically, the non-volatile memory 208 according to the first embodiment stores therein a keyboard device table that associates identification information of a keyboard connected to the electronic device 100 with keys arranged on the keyboard. Referring to the keyboard device table makes it possible to check the keys arranged on the keyboard device 150 connected to the electronic device 100. Since reference to the keyboard device table also enables the display module 212 to check the keys arranged on the keyboard device 150 thus connected, the display module 212 can display a software keyboard on which keys not included in the keyboard device 150 are arranged. The keyboard device table is updated if the arrangement of the keys on the keyboard device 150 thus connected is changed.

In the case of a keyboard device in which the arrangement of keys cannot be changed unlike the first embodiment, the non-volatile memory 208 may store therein an association table that associates the type of the keyboard device with a software keyboard (on which keys not included in the keyboard device are arranged) to be displayed when the keyboard of the type is connected. If the type of the keyboard device connected to the electronic device 100 is determined, the display module 212 can refer to the association table to display the software keyboard on which keys not included in the keyboard are arranged.

If the acquisition module 211 acquires the key codes indicating the keys arranged on the keyboard device 150, the display module 212 can identify the keys not arranged on the keyboard device based on the key codes thus acquired. The key codes of the keys not arranged on the keyboard device can be identified by deriving difference of key codes between all the key codes of keys displayable as the software keyboard retained in the control program 201a and the key codes acquired by the acquisition module 211, for example.

The display module 212 then displays the software keyboard on which only the keys not included in the keyboard device are arranged on the display screen 101a.

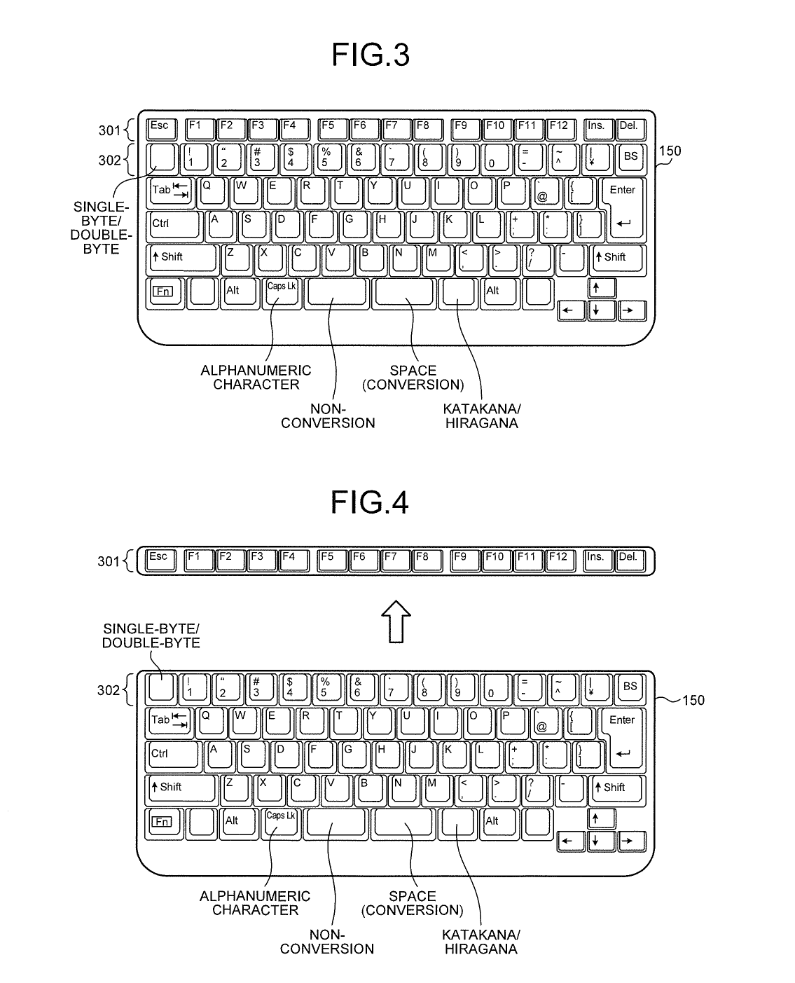

The keyboard device 150 will now be described. FIG. 3 is a schematic diagram of an example of the keyboard device 150. In the example illustrated in FIG. 3, the keyboard device 150 comprises a row 301 provided with function keys and a row 302 provided with numeric keys. In response to a request from the electronic device 100, the keyboard device 150 transmits the key codes of all the keys arranged on the keyboard unit.

The display module 212 of the electronic device 100 can display all the keys arranged on the keyboard unit provided to the keyboard device 150 illustrated in FIG. 3 as the soft keyboard. If the keyboard device 150 is connected to the electronic device 100, the display module 212 identifies keys displayable as the software keyboard based on the key codes transmitted from the keyboard device 150. Because all the keys displayable as the software keyboard are arranged on the keyboard device 150 in the example of FIG. 3, the display module 212 displays no software keyboard.

The keyboard device 150 is a keyboard whose keys are attachable and detachable thereto and therefrom for each key. FIG. 4 is a schematic diagram illustrating an example where a row 301 provided with the function keys is removed from the keyboard device 150. To improve the portability of the keyboard device 150, the user can remove low-use keys (e.g., the row 301 of the function keys) in this manner. The attachable and detachable keys are not limited to the row 301 provided with the function keys, and any key is attachable and detachable in a key unit in addition to the row 302 provided with the numeric keys.

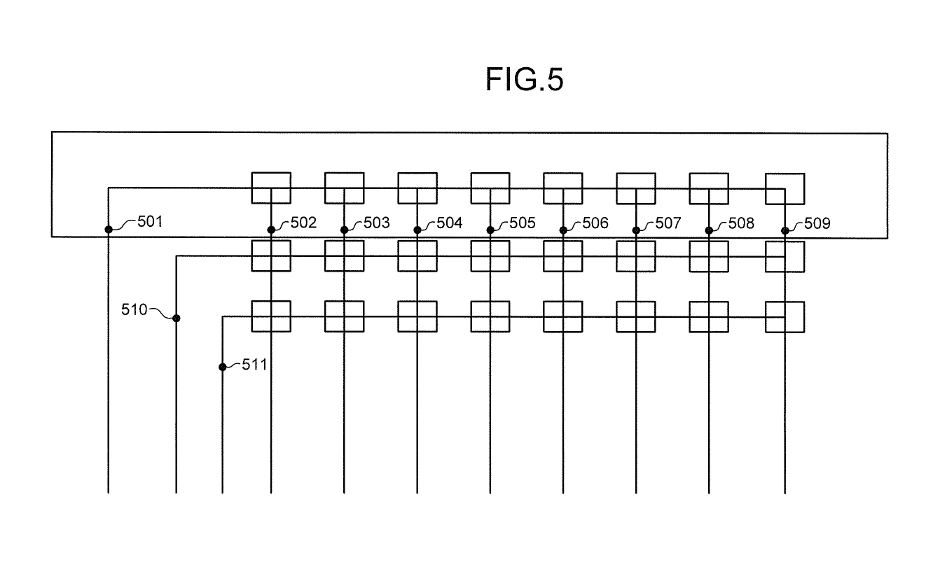

FIG. 5 is a schematic diagram of an example of wiring of keys on the keyboard device 150. In the example illustrated in FIG. 5, the wiring is terminated with terminations 501 to 511 in a key unit. This configuration enables the keys to be attached to and detached from the keyboard for each key. This is given just as an example of attachment and detachment of the keys by each key unit, and another method can be employed in the first embodiment.

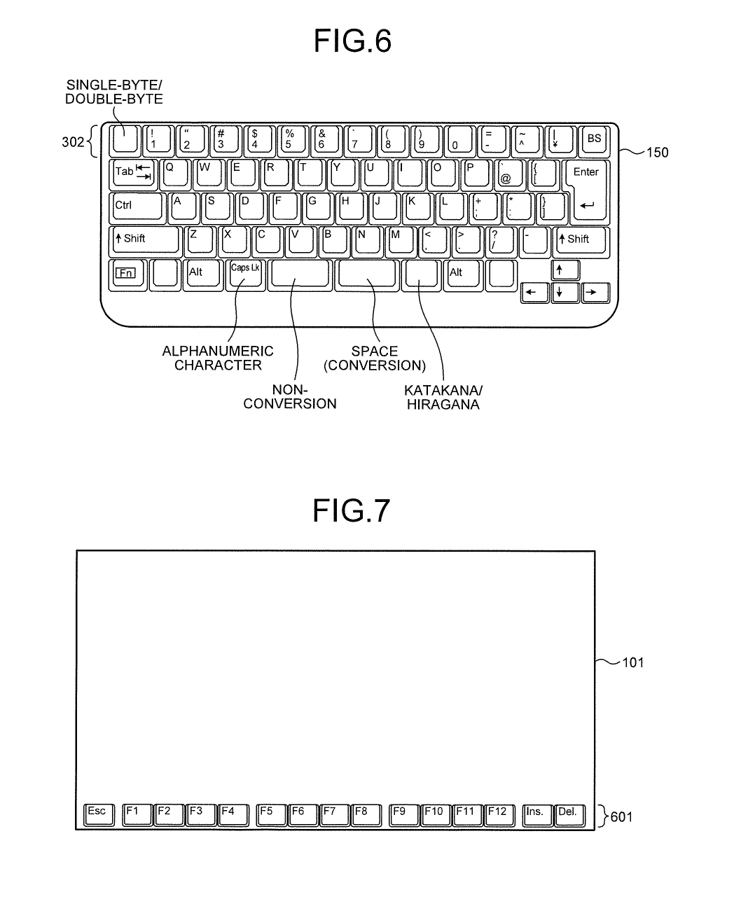

FIG. 6 is a schematic diagram of an example of the keyboard device 150 from which the row 301 provided with the function keys is removed. As illustrated in the example of FIG. 6, the uppermost row of the keyboard unit is the row 302 provided with the numeric keys.

In this case, based on the key codes acquired by the acquisition module 211 of the electronic device 100 from the keyboard device 150, the display module 212 can determine that no function key or the like is provided. Thus, the display module 212 displays the row of the function keys not arranged on the keyboard device 150 as a software keyboard based on the key codes thus acquired.

FIG. 7 is a schematic diagram of an example of a software keyboard displayed by the display module 212 when the keyboard device 150 illustrated in FIG. 6 is connected to the electronic device 100. As illustrated in FIG. 7, the display device 101 displays a row 601 of the function keys. This makes it possible to complement the keys on the keyboard device 150 illustrated in FIG. 6, thereby improving the operability. Furthermore, because the area occupied by the software keyboard is small in the display screen 101a of the display device 101, the user can comfortably use other software displayed in an area other than the area.

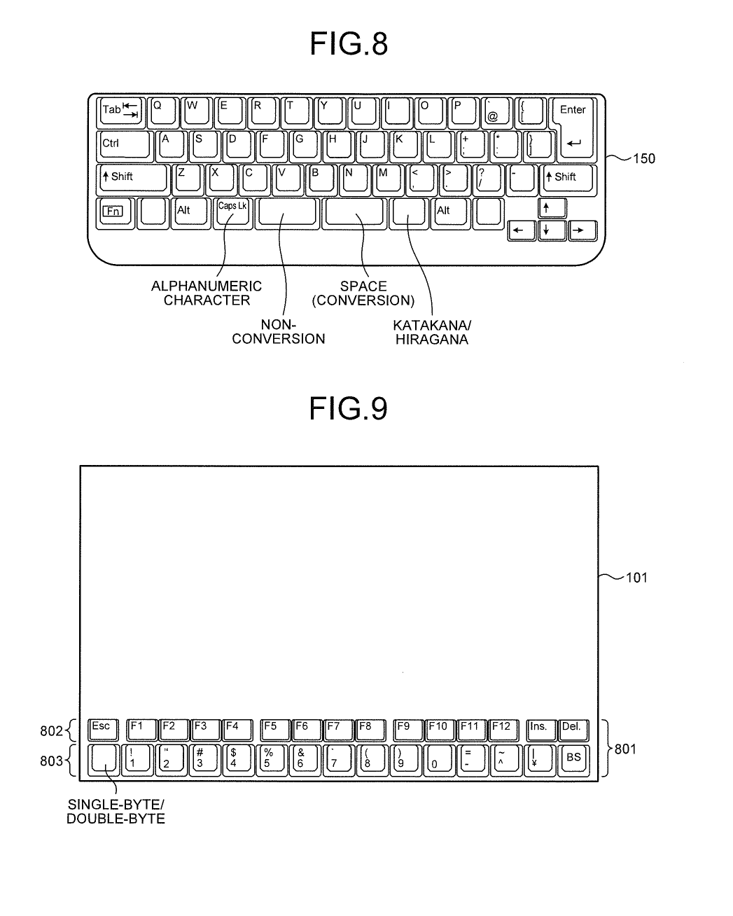

FIG. 8 is a schematic diagram of an example of the keyboard device 150 from which the row 302 provided with the numeric keys is removed. As illustrated in the example of FIG. 8, the uppermost row of the keyboard unit is a row provided with alphabetical letter keys and the like.

In this case, based on key codes acquired by the acquisition module 211 of the electronic device 100 from the keyboard device 150, the display module 212 can determine that no function key, numeric key, or the like is provided. Thus, the display module 212 displays the rows of the function keys and the numeric keys not provided to the keyboard device 150 as a software keyboard based on the key codes thus acquired.

FIG. 9 is a schematic diagram of an example of a software keyboard 801 displayed by the display module 212 when the keyboard device 150 illustrated in FIG. 8 is connected to the electronic device 100. As illustrated in FIG. 9, the display device 101 displays a row 802 of the function keys and a row 803 of the numeric keys as the software keyboard 801. This makes it possible to complement the keys on the keyboard device 150 illustrated in FIG. 8, thereby improving the operability.

Referring back to FIG. 2, the receiver 213 receives input of the keys displayed as the soft keyboard on the display screen 101a of the display device 101 via the touch panel 101b.

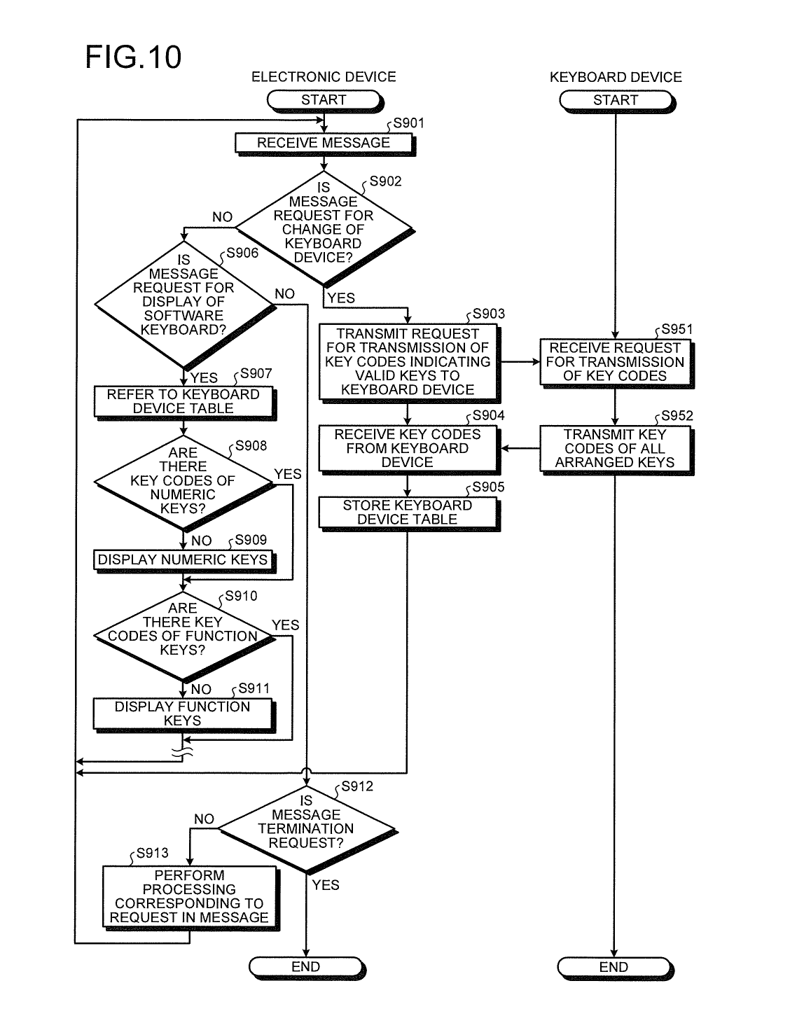

An explanation will be made of the display processing of the software keyboard in the electronic device 100 and the keyboard device (input device) 150 according to the first embodiment. FIG. 10 is a flowchart of a process of the processing described above in the electronic device 100 and the keyboard device 150 according to the first embodiment. In the example illustrated in FIG. 10, the electronic device 100 and the keyboard device 150 are already connected to each other.

The control program 201a of the electronic device 100 receives a message from the system controller 202 (S901). The control program 201a then determines whether the message is a request for change of the keyboard device (input device) 150 (S902). The request for change includes change of keys arranged on the keyboard device 150, for example, besides change of the keyboard device 150 thus connected.

If the control program 201a determines that the message is a request for change of the keyboard device 150 (Yes at S902), the acquisition module 211 transmits a request for transmission of key codes of all the keys capable of being input to the keyboard device (input device) 150 thus connected via the wireless communication module 205 (S903).

The keyboard device 150 receives the request for transmission of the key codes of all the keys capable of being input (S951). The keyboard device 150 then transmits key codes of all the keys arranged on the keyboard unit (S952).

Subsequently, the acquisition module 211 of the control program 201a of the electronic device 100 receives the key codes from the keyboard device 150 (S904).

The acquisition module 211 then stores the key codes thus acquired in the keyboard device table in association with the information for identifying the keyboard device 150 (S905). Subsequently, the system control is returned to S901.

By contrast, if the control program 201a determines that the message is not a request for change of the keyboard device 150 (No at S902), the control program 201a determines whether the message is a request for display of a software keyboard (S906).

If the control program 201a determines that the message is a request for display of a software keyboard (Yes at S906), the acquisition module 211 refers to the keyboard device table (S907) to acquire the key codes of the keys arranged on the keyboard device 150. The display module 212 then determines whether the key codes thus acquired include key codes of numeric keys (S908). If the display module 212 determines that the key codes include key codes of numeric keys (Yes at S908), the system control goes to S910.

By contrast, if the display module 212 determines that the key codes include no key code of a numeric key (No at S908), the display module 212 displays the numeric keys as a part of the software keyboard (S909).

The display module 212 then determines whether the key codes thus acquired include key codes of function keys (S910). If the display module 212 determines that the key codes include key codes of function keys (Yes at S910), the system control goes to the subsequent processing without displaying the function keys.

By contrast, if the display module 212 determines that the key codes include no key code of a function key (No at S910), the display module 212 displays the function keys as a part of the software keyboard (S911). If the numeric keys are already displayed, the display module 212 displays the function keys on top of the numeric keys.

Subsequently, while illustration is omitted, the display module 212 determines whether the key codes of all the keys displayable as the software keyboard are received in a key unit and displays the software keyboard based on the determination result. The system control is then returned to S901.

By contrast, if the control program 201a determines that the message is not a request for display of a software keyboard at S902 (No at S906), the control program 201a determines whether the message thus received is a termination request (S912). If the control program 201a determines that the message is not a termination request (No at S912), the processing corresponding to the request in the message is performed (S913), and the system control is returned to S901.

By contrast, if the control program 201a determines that the message is a termination request (Yes at S912), the processing is terminated.

With the processing described above, the electronic device 100 can display the software keyboard on which keys not provided to the keyboard device 150 connected to the electronic device 100 are arranged and keys provided to the keyboard device 150 are omitted.

While the explanation has been made of the request for transmission of the key codes in the flowchart, the request is not limited to the request for transmission of the key codes and may be a request for transmission of the type of the keyboard, for example. If the type of the keyboard is transmitted, keys not provided to the keyboard can be identified based on the type of the keyboard. Therefore, processing similar to that of FIG. 10 can be performed.

Furthermore, while the explanation has been made of the case where the keyboard device 150 can respond to the request for transmission of the key codes in the flowchart, the first embodiment is not necessarily applied to a keyboard device having such a function. The electronic device 100, for example, may prompt the user to press all the keys on the keyboard device thus connected. In this case, the electronic device 100 determines the key codes transmitted from the keyboard device to be the keys arranged on the keyboard device and displays a software keyboard formed of the keys of the key codes not transmitted. As a result, even if the keyboard device has no response function, the electronic device 100 can display a software keyboard corresponding to the keyboard device.

While the explanation has been made of the case where the software keyboard to be displayed is changed by attaching and detaching arbitrary keys to and from the keyboard device in the first embodiment, the method for changing the software keyboard is not limited thereto. The software keyboard to be displayed may be changed depending on the connection status of a plurality of types of keyboards with different numbers of keys connected to the electronic device 100.

According to the first embodiment, it is possible to remove low-use keys from the keyboard device. As a result, downsizing of the keyboard device can be achieved.

While the explanation has been made of the case where the keyboard device 150 is connected to the electronic device 100 in the first embodiment, the number of the input device thus connected is not necessarily one. In a second embodiment, an explanation will be made of the case where a plurality of input devices are connected to an electronic device.

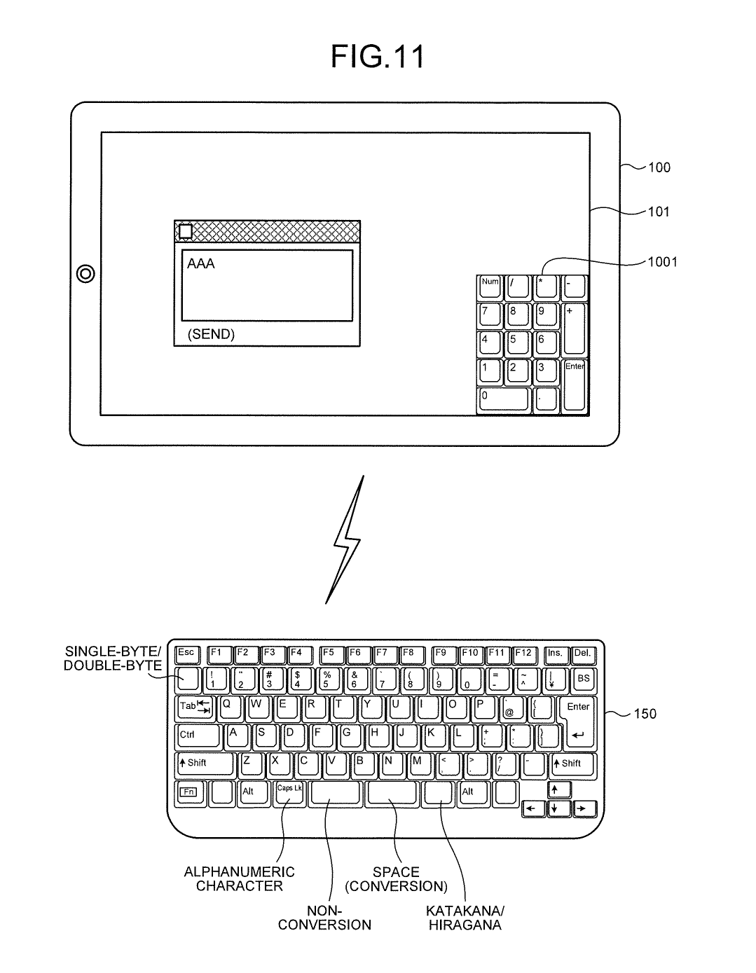

FIG. 11 is a schematic diagram of a configuration of an electronic device 100 and a keyboard device 150 serving as a keyboard control system according to the second embodiment. In the example illustrated in FIG. 11, the electronic device 100 can display all the keys of a full keyboard including a numeric keypad as a software keyboard. In this case, if the electronic device 100 is connected to the keyboard device 150, a display module 212 of a control program 201a displays a numeric keypad 1001 not included in the keyboard device 150 as a software keyboard.

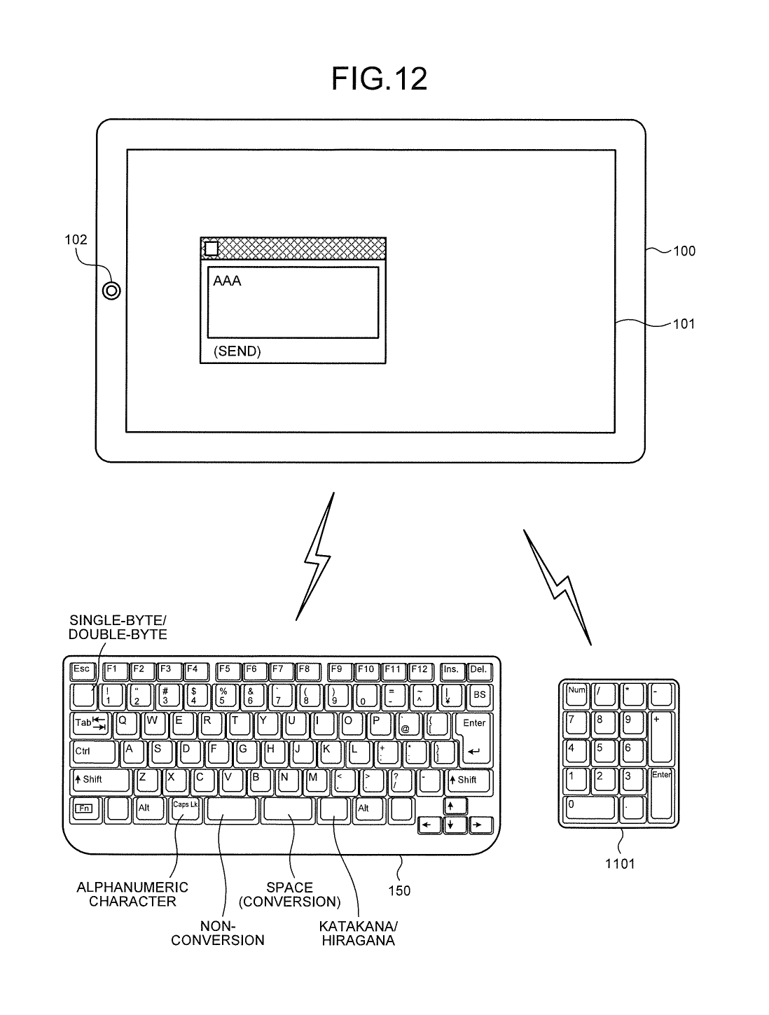

FIG. 12 is a schematic diagram illustrating an example where the electronic device 100 according to the second embodiment is connected to a plurality of input devices. In the example illustrated in FIG. 12, the electronic device 100 is connected to the keyboard device 150 and a numeric keypad device 1101.

An acquisition module 211 of the electronic device 100 acquires key codes of all the keys arranged on each keyboard unit from the keyboard device 150 and the numeric keypad device 1101.

The display module 212 displays a software keyboard based on the key codes acquired by the acquisition module 211 from the input devices. If the input devices are connected via a wireless communication module 205 and a connection I/F 206, the display module 212 according to the second embodiment displays a software keyboard on which keys not included in at least one of the keyboard units of the input devices are arranged.

In the example illustrated in FIG. 12, if the keyboard device 150 and the numeric keypad device 1101 are connected to the electronic device 100 in combination, the display module 212 displays no software keyboard because the electronic device 100 comprises all the keys including the numeric keypad 1001.

As described above, the electronic device 100 according to the second embodiment can change the display format of the software keyboard depending on the number of input devices thus connected. Therefore, the operability can be improved for the user.

While the explanations have been made of the case where the electronic device 100 determines the keyboard connected thereto and displays the software keyboard in the first and the second embodiments, the user may change the keys to be displayed as a software keyboard.

In a third embodiment, an explanation will be made of an example of a software keyboard including keys desired by the user regardless of an input device connected to an electronic device 100.

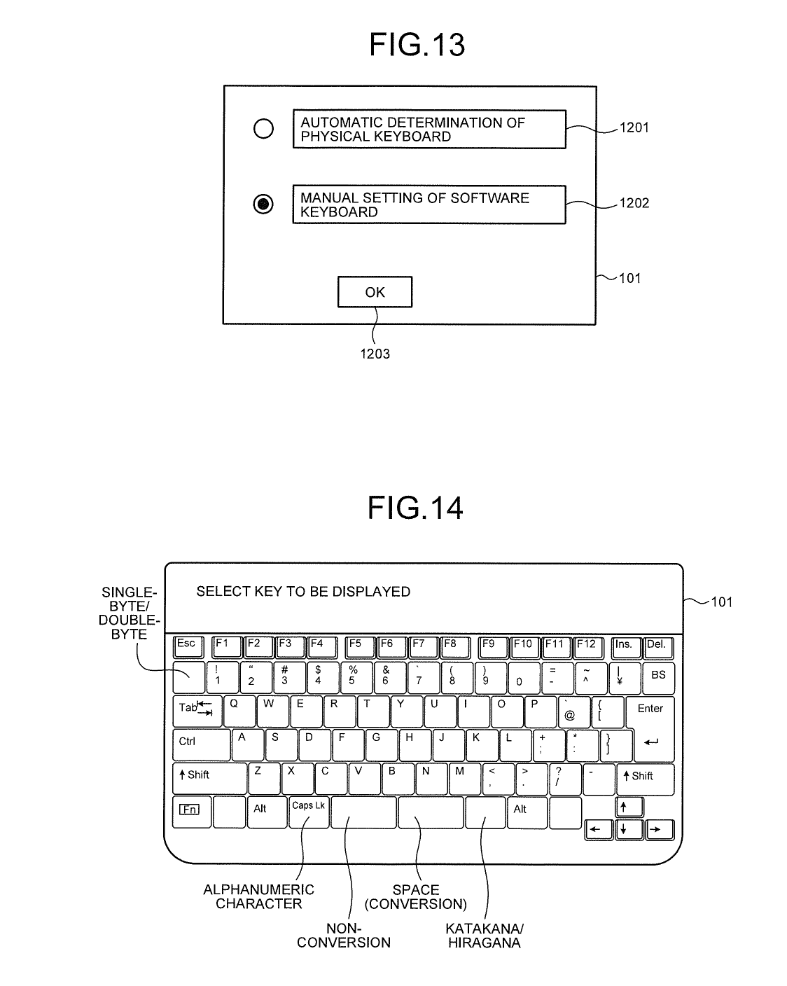

If a predetermined operation is received from the user, a display module 212 according to the third embodiment displays a setting screen of a software keyboard. FIG. 13 is a schematic diagram of an example of the setting screen displayed by the display module 212. On the setting screen illustrated in FIG. 13, a receiver 213 can receive selection of “automatic determination of physical keyboard” 1201 or “manual setting of software keyboard” 1202. If the receiver 213 receives pressing of an OK button 1203 after receiving selection of “automatic determination of physical keyboard” 1201 or “manual setting of software keyboard” 1202, a control program 201a performs control based on the selection.

If the receiver 213 receives selection of “automatic determination of physical keyboard” 1201, for example, processing to be performed is similar to that in the first and the second embodiments, and the explanation thereof will be omitted.

By contrast, if the receiver 213 receives selection of “manual setting of software keyboard” 1202, the display module 212 displays a list of displayable keys.

FIG. 14 is a schematic diagram of an example of a list screen of displayable keys displayed by the display module 212 according to the third embodiment. The receiver 213 receives selection of display or non-display of each key from the list of keys illustrated in FIG. 14 by an operation performed by the user so as to display a software keyboard on a display screen 101a.

If a message to display a software keyboard is received, the display module 212 displays a software keyboard based on the selection from the list illustrated in FIG. 14 regardless of whether the keys thus selected are included in a keyboard unit of the input unit connected to the electronic device 100. In other words, the display module 212 displays a software keyboard formed of the keys selected to be displayed as the software keyboard from the list of keys illustrated in FIG. 14.

According to the third embodiment, it is possible to display only the keys not arranged on the keyboard unit of the input device connected to the electronic device 100 on the software keyboard. As a result, the user need not use a keyboard on which low-use keys are arranged. Therefore, it is possible to improve the portability of the electronic device 100 and the keyboard device.

Furthermore, the user can input even the keys not arranged on the keyboard device with the software keyboard. Thus, using the keyboard device and the software keyboard in combination makes it possible to maintain the number of keys capable of being input. Therefore, the operability when using a keyboard device with a small number of keys can be improved.

The control program 201a executed in the electronic device 100 according to the first to the third embodiments is provided in a manner recorded in a computer-readable recording medium, such as a compact disk read-only memory (CD-ROM), a flexible disk (FD), a compact disk recordable (CD-R), and a digital versatile disk (DVD), as a file in an installable or executable format.

The control program 201a executed in the electronic device 100 according to the first to the third embodiments may be provided in a manner stored in a computer connected to a network such as the Internet to be made available for downloads via the network. Furthermore, the control program 201a executed in the electronic device 100 according to the first to the third embodiments may be provided or distributed over a network such as the Internet.

The control program 201a according to the first to the third embodiments may be provided in a manner incorporated in a ROM and the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a connector configured to be connectable to a device comprising a keyboard;
a display module configured to display a software keyboard on which a key not comprised in the keyboard of the device is arranged when the device is connected to the connector; and
a receiver configured to receive input from the key displayed as the software keyboard on the display module.

2. The electronic device of claim 1, further comprising:
an acquisition module configured to acquire a type of the device connected via the connector or a key code arranged on the keyboard provided to the device, wherein
the display module is configured to display the software keyboard on which the key not comprised in the keyboard of the device is arranged based on the type of the device or the key code acquired by the acquisition module.

3. The electronic device of claim 1, wherein
the connector is configured to be connectable to a plurality of devices provided with keyboards, and
the display module is configured to display the software keyboard on which a key not comprised in all of the keyboards of the devices is arranged when the devices are connected to the connector.

4. The electronic device of claim 1, wherein
the receiver is configured to receive selection of a key to be displayed on the display module from keys displayable as the software keyboard, and
the display module is further configured to display the software keyboard arranged based on the key of which the selection is received by the receiver, regardless of whether the key is comprised in the keyboard of the device.

5. A keyboard control system comprising:
a device comprising a keyboard; and
an electronic device, wherein
the electronic device comprises:
a connector connectable to the device comprising the keyboard;
a display module configured to display a software keyboard on which a key not comprised in the keyboard of the device is arranged when the device is connected to the connector; and
a receiver that receives input from the key displayed as the software keyboard on the display module.

6. The keyboard control system of claim 5, wherein, in the device comprising the keyboard, a key arranged on the keyboard is configured to be attachable and detachable.

7. A display control method performed in an electronic device comprising a connector connectable to a device comprising a keyboard, the display control method comprising:
displaying a software keyboard on which a key not comprised in the keyboard of the device is arranged when the device is connected to the connector; and
receiving an input from the key displayed as the software keyboard at the displaying.

8. A computer program product having a non-transitory computer readable medium including programmed instructions, wherein the instructions, when executed by a computer, cause the computer to perform:
connecting to a device comprising a keyboard;
displaying a software keyboard on which a key not comprised in the keyboard of the device connected at the connecting is arranged; and
receiving an input from the key displayed as the software keyboard at the displaying.
